(19) United States
(12) Patent Application Publication
(10) Pub. No.: US 2008/0104788 A1
(43) Pub. Date: May 8, 2008

(54) Concrete Finishing Handle, Tool and Kit Assemblies

(76) Inventor: Fred Wothers, Harrington, DE (US)

Correspondence Address: HALL, VANDE SANDE & PEQUIGNOT, LLP, 1636 R STREET N.W., THIRD FLOOR, WASHINGTON, DC, 20009, US

(21) Appl. No.: 11/556,691

(22) Filed: Nov. 4, 2006

(51) Int. Cl. B05C 17/10; B28B 11/18

(52) U.S. Cl. 15/235.8; 264/162

(57) ABSTRACT

The present invention is directed to tool handle assemblies, tools and kits for finishing wet concrete and like materials. The inventive tool handle assemblies are of a unique shape that permit a worker using a tool employing them to finish concrete with greater efficiency. Methods of using the inventive tool handle assemblies, tools and kits are also described.

### FIELD OF THE INVENTION

The present invention relates to tool handle assemblies and tools employing such tool handle assemblies for finishing concrete and like materials. In certain preferred embodiments, the present invention relates to tool handle assemblies that bend in at least two directions, permitting a worker to finish concrete while walking adjacent and in substantially parallel orientation to the area being finished, such as with a sidewalk. In certain other embodiments, the present invention relates to kits having such tool handle assemblies and tools, as well as methods of using such tool handle assemblies and tools.

### BACKGROUND OF THE INVENTION

Concrete slabs are generally formed by pouring wet concrete into forms, spreading the concrete, screeding the wet concrete to work out high and low spots, and then floating the wet concrete to smooth the surface by pushing down large aggregate and raising the gravel-free concrete to the surface. The concrete may be further finished for aesthetic or functional purposes as desired. For example, a broom is often drawn over the wet concrete so that the cured concrete will have a textured surface.

Large areas of concrete are usually smoothed/finished with a bull float tool which has a relatively large bull float attached to an elongated handle. The bull float tool is typically used by a masonry worker to finish the wet concrete by pushing the bull float tool away while concurrently causing the leading edge of the bull float to angle slightly upward, so that it does not gouge the wet concrete, and then drawing the bull float tool backward such that the bull float is either flat on the wet concrete or such that the trailing edge of the bull float is angled slightly upward, as needed to ensure that it does not gouge the newly smoothed concrete. Numerous conventional bull float tools produced of various materials and having various designs and features are known in the art for the aforementioned purposes.

Although generally effective for finishing wet concrete when used by skilled masonry worker, conventional bull float tools have numerous limitations, one of the most significant being that they are generally only useful for working on a relatively small area of concrete at any given time. For example, when using a conventional bull float tool to finish a wet concrete sidewalk, a worker typically uses the tool while oriented generally perpendicular to the forms supporting the wet concrete. This requires the worker to push the bull float tool forward and draw it backward at least once, and typically several times, for each cross-sectional area of the sidewalk defined by a width generally comparable to the width of the bull float. As such, in order to finish the entire sidewalk, this labor-intensive, and consequently costly, process must be repeated numerous times until the entire length of the sidewalk has been finished.

Moreover, the worker generally must stretch to reach across such cross-section of the sidewalk and/or walk in the wet concrete (depending on certain factors such as the width of the sidewalk, the length of the bull float handle, and other factors), bend excessively, and work backward to complete the finishing processes. Several passes over the wet concrete with the bull float are also typically required to achieve a desirable finished surface, further increasing the worker's labor requirements. Moreover, time is generally of the essence during the finishing process, due to the gradual change in the workability of the concrete once poured, and as such the limitations with known tools may limit the amount of wet concrete that may be mixed and poured at a single time and/or increase the required skill needed by a worker to ensure a proper finish.

Accordingly, there is a need for bull float tools that overcome the aforementioned limitations of conventional bull float tools, so as to permit a worker to properly finish a wet concrete surface in an efficient manner. It is to these and other needs that the present invention is directed.

### SUMMARY OF THE INVENTION

In one aspect, the present invention is directed to a tool handle assembly, having: a shaft member which is capable of direct or indirect attachment to a finishing member, such as a bull float; an intermediate member cooperative with the shaft member, wherein the intermediate member is offset from the longitudinal axis of the shaft member; and an elongated handle member cooperative with the intermediate member, wherein the elongated handle member is offset from the longitudinal axis of the intermediate member; and wherein the shaft member, intermediate member and handle member together define a tool handle assembly that is capable of direct or indirect attachment at the shaft member to a finishing member to form a finishing tool, and wherein the handle member is so elongated as to permit a worker using a finishing tool having the tool handle assembly to cause the finishing member to contact and move substantially horizontally across the surface of a material being finished, such as concrete.

The tool handle assembly may further comprise one or more support members, each adjoining at least two adjacent members of the group consisting of the shaft member, the intermediate member, and the elongated handle member. The intermediate member may be offset from the longitudinal axis of the shaft member so as to form an inner angle of more than 90 degrees and less than 180 degrees therebetween, and preferably of about 135 degrees. The elongated handle member may be offset from the longitudinal axis of the intermediate member so as to form an inner angle of more than 90 degrees and less than 180 degrees therebetween, and preferably of about 135 degrees.

In another aspect, the present invention is directed to a bull float tool, having: the aforementioned bull float handle assembly, a bull float bracket, and a finishing member, such as a bull float.

In another aspect, the present invention is directed to a bull float tool, having: a shaft member; a bull float, wherein the shaft member is directly or indirectly attached to the bull float; an intermediate member cooperative with the shaft member, wherein the intermediate member is offset from the longitudinal axis of the shaft member; an elongated handle member cooperative with the intermediate member, wherein the elongated handle member is offset from the longitudinal axis of the intermediate member; and wherein the handle member is so elongated as to permit a worker using the bull float tool to cause the bull float to contact and move substantially horizontally across the surface of a material being finished. The bull float tool may further comprise a bull float bracket and one or more support members, each adjoining at least two of the shaft member, the intermediate member, and the elongated handle member.

In another aspect, the present invention is directed to a kit, having: a tool handle assembly shaft member which is capable of direct or indirect attachment to a finishing member; a tool handle assembly intermediate member which may be joined with the shaft member, wherein the intermediate member is offset from the longitudinal axis of the shaft member once joined; and a tool handle assembly elongated handle member which may be joined with the intermediate member, wherein the elongated handle member is offset from the longitudinal axis of the intermediate member once joined; wherein the tool handle assembly shaft member, intermediate member and handle member may be joined to form a tool handle assembly that is capable of direct or indirect attachment to a finishing member to form a finishing tool, and wherein the handle member is so elongated as to permit a worker using a finishing tool employing the tool handle assembly to cause the finishing member to contact and move substantially horizontally across the surface of a material being finished.

In another aspect, the present invention is directed to a bull float tool, having: a shaft member; a bull float bracket attached to the shaft member; a bull float attached to the bull float bracket; an intermediate member cooperative with the shaft member, wherein the intermediate member is offset from the longitudinal axis of the shaft member; an elongated handle member cooperative with the intermediate member, wherein the elongated handle member is offset from the longitudinal axis of the intermediate member; and wherein the handle member is so elongated as to permit a worker using the bull float tool to cause the bull float to contact and move substantially horizontally across the surface of a material being finished.

In another aspect, the present invention is directed to a method of finishing concrete or like material, the method including the steps of: (a) providing a bull float tool, having: a shaft member; a bull float, wherein the shaft member is directly or indirectly attached to the bull float; an intermediate member cooperative with the shaft member, wherein the intermediate member is offset from the longitudinal axis of the shaft member; an elongated handle member cooperative with the intermediate member, wherein the elongated handle member is offset from the longitudinal axis of the intermediate member; wherein the handle member is so elongated as to permit a worker using the bull float tool to cause the bull float to contact and move substantially horizontally across the surface of a material being finished; and (b) contacting the bull float tool with a wet concrete surface to be finished.

### BRIEF DESCRIPTION OF THE DRAWINGS

FIG. 1 shows a top perspective view of a conventional bull float tool.

FIG. 2 shows a top plan view of a tool handle assembly of the present invention.

FIG. 3 shows a top plan view of a bull float tool of the present invention.

FIG. 4 shows a top perspective view of a bull float bracket for use with bull float tool handle assemblies and bull float tools of the present invention.

FIG. 5 shows a top perspective view of a bull float tool of the present invention.

FIG. 6 shows a top perspective view of a worker using a bull float tool of the present invention.

### DETAILED DESCRIPTION OF CERTAIN EMBODIMENTS

For a more complete understanding of the present invention and advantages thereof, reference is now made to the following description of various illustrative and non-limiting embodiments thereof, taken in conjunction with the accompanying drawings in which like reference numbers indicate like features.

The present invention relates to tool handle assemblies and tools and kits employing such tool handle assemblies. In particular, the present invention relates to tool handle assemblies for use in bull float tools for finishing (as that term is understood in the masonry arts, and specifically including smoothing) wet concrete. As discussed in more detail and shown in the Figures below, tool handle assemblies of the present invention bend in at least two directions, permitting a worker to work on a material that is oriented to the side of the worker.

For example, when working on a wet concrete sidewalk, a worker using a bull float tool of the present invention may finish concrete while walking adjacent and in substantially parallel orientation to the forms supporting the concrete, in contrast to the more labor-intensive process of finishing one cross-sectional area of the sidewalk at a time. Among other benefits, this reduces the frequency with which the bull float tool must be pushed forward and drawn backward by the worker; the need for the worker to reach/stretch across the sidewalk and/or walk in the wet concrete; the need for the worker to excessively bend at the knees and/or the waist; and the need for the worker to excessively walk and work backward.

Moreover, to produce a desirable finish, a worker typically causes the leading edge of the bull float to angle slightly upward while pushing the tool in a forward direction so as not to gouge the wet concrete, and subsequently draws the tool backward so that the bull float is substantially flat against the concrete or alternatively such that the trailing edge of the bull float is angled slightly upward, as determined by the skilled worker to ensure that the concrete is not gouged.

The bull float is typically caused to angle slightly upward as a result of slight downward pressure placed on the bull float handle by the worker or by use of a specialized bull float bracket which causes the bull float to angle slightly upward in response to the worker twisting the bull float handle. As such, the reduced need for the worker to move the bull float tool forward and backward during the finishing process afforded by the present invention likewise reduces the labor and time required to repeatedly cause the bull float head to be angled upward as the tool is pushed forward and, also potentially angled upward as the bull float tool is drawn backward.

Further, where it may be desired to work on a material while oriented generally perpendicular to the thereto, tools of the present invention permit, as a result of their unique shape and other features, the worker to work on a first area to one side of his body, and then readily reposition the tool to the other side of his body and work on a second area, without the need for substantially changing his position. Moreover, tools of the present invention permit a worker to reach areas not accessible with conventional bull float tools.

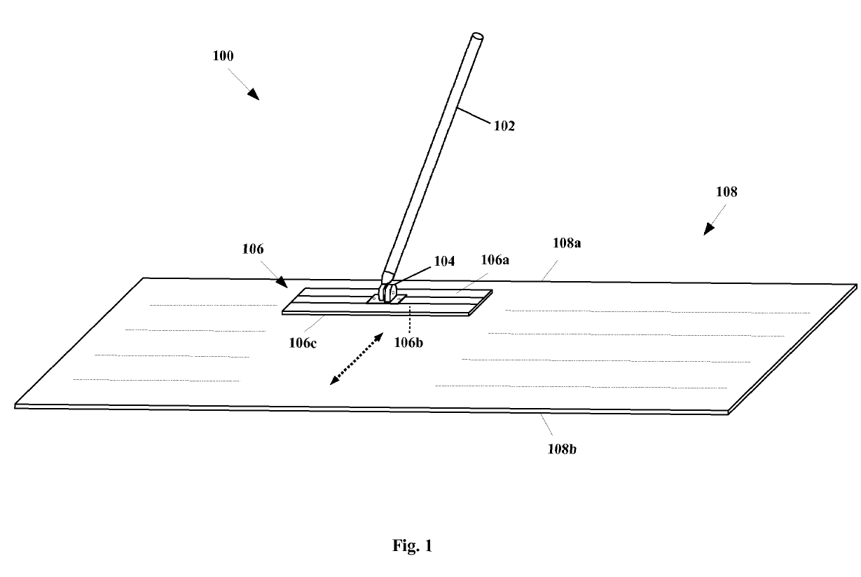

With reference to the accompanying drawings, FIG. 1 shows a conventional bull float tool 100, which includes an elongated bull float handle 102 connected to a bull float bracket 104, which in turn is connected to a bull float 106. Bull float 106 has a top surface 106a which attaches to bull float bracket 104, a bottom surface 106b that contacts wet concrete, and a leading edge 106c.

To smooth a wet concrete sidewalk 108 with conventional bull float tool 100, a worker typically grasps elongated bull float handle 102 and pushes bull float tool 100 in a forward direction from the near edge 108a of the sidewalk 108 to the far edge 108b of the sidewalk 108, as shown by dotted arrow, while causing the leading edge 106c of bull float 106 to angle slightly upward as bull float tool 100 moves forward, so that it does not gouge the wet concrete that is being smoothed by the bottom surface 106b of bull float 106.

In this regard, the leading edge 106c of bull float 106 may be caused to angle slightly upward by the worker in any number of ways, for example by applying appropriate downward pressure to elongated bull float handle 102 or by the use of a specialized bull float bracket that causes the leading edge 106c of bull float 106 to angle upward in response to twisting of elongated bull float handle 102. As aforementioned, conventional bull float tools, such as the one shown in FIG. 1, have numerous limitations as a result of their design and functionality.

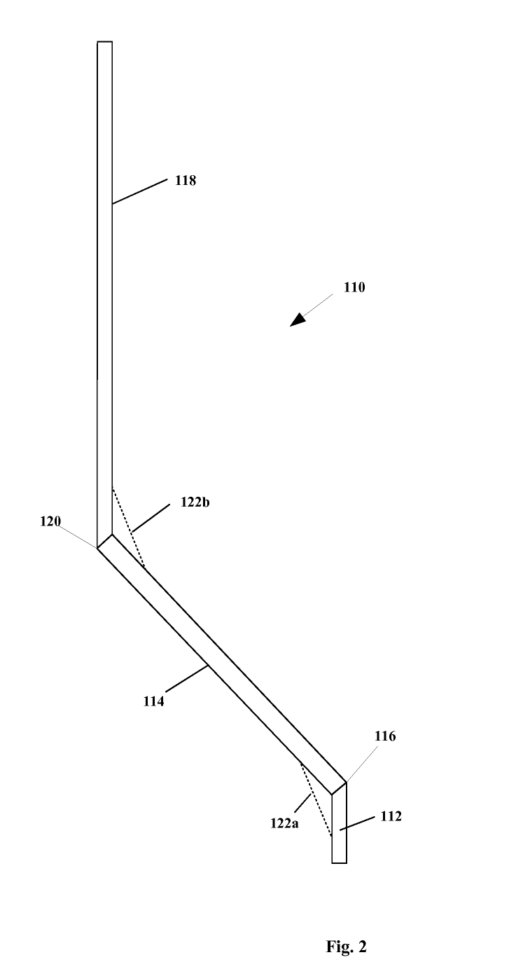

Referring now to FIG. 2, a bull float handle assembly 110 of the present invention is shown. Bull float handle assembly 110 includes a shaft member 112 which is cooperative with an intermediate member 114, such that a first bend 116 is formed therebetween. Intermediate member 114 is in turn cooperative with an elongated handle member 118, such that a second bend 120 is formed therebetween.

As used herein, to state that a first member is cooperative with a second member means, for example and without limitation, that movement of such first member results in movement of such second member. Cooperation between such members may result form the members being contiguous, such that they are either fixedly or removably attached to each other, or from the members being integral with each other, such as when they are formed from a single piece of material.

In this regard, when such members are contiguous they may be, for example, attached to each other by any number of means that permit the proper functionality of the inventive bull float handle assemblies and tools. For example, the members may be welded together; they may be held together by screws or the like; they may be held together by a push-pin type mechanism, for example where ready detachment of the members is desired for portability; they may be held together by tapering one member to fit inside the other member; they may be attached by screwing them directly together where one member incorporates female threads and the other incorporates male threads; and/or by any number of other means.

Moreover, as will be appreciated by those of skill in the art, in various embodiments the members may be fixedly or removably attached to each other as desired to suit particular purposes or as dictated by manufacturing or other concerns. For example, they may be welded together when a permanent and strong attachment is desired; or they may be directly or indirectly screwed together such that the inventive handle assemblies and tools may be readily disassembled, such as for use in kits when portability is desired.

Alternatively or in combination, certain such members may be integral with each other, such as when they are machined or otherwise formed from a continuous piece of material such as plastic or metal. For example, a continuous piece of steel or aluminum may be bent so as to form respective first and second bends 116 and 120, thereby defining the members of tool handle assembly 110. Likewise, a plastic material may be extruded or molded so as to form such bends and define such distinct members.

As further shown by dotted lines in FIG. 2, one or more optional support members 122a and/or 122b may be present in the inventive tool handle assemblies to provide support as necessary at respective first and second bends 116 and 120. Such support members may each be, for example and without limitation, a solid triangularly-shaped member that sits within a bend, or a linear member that adjoins two members to define an interior space therebetween. One of skill in the art will appreciate that the presence, configuration, size, material and degree of fixation of each such support member will be determined by the intended functionality of the inventive handle assemblies and tools.

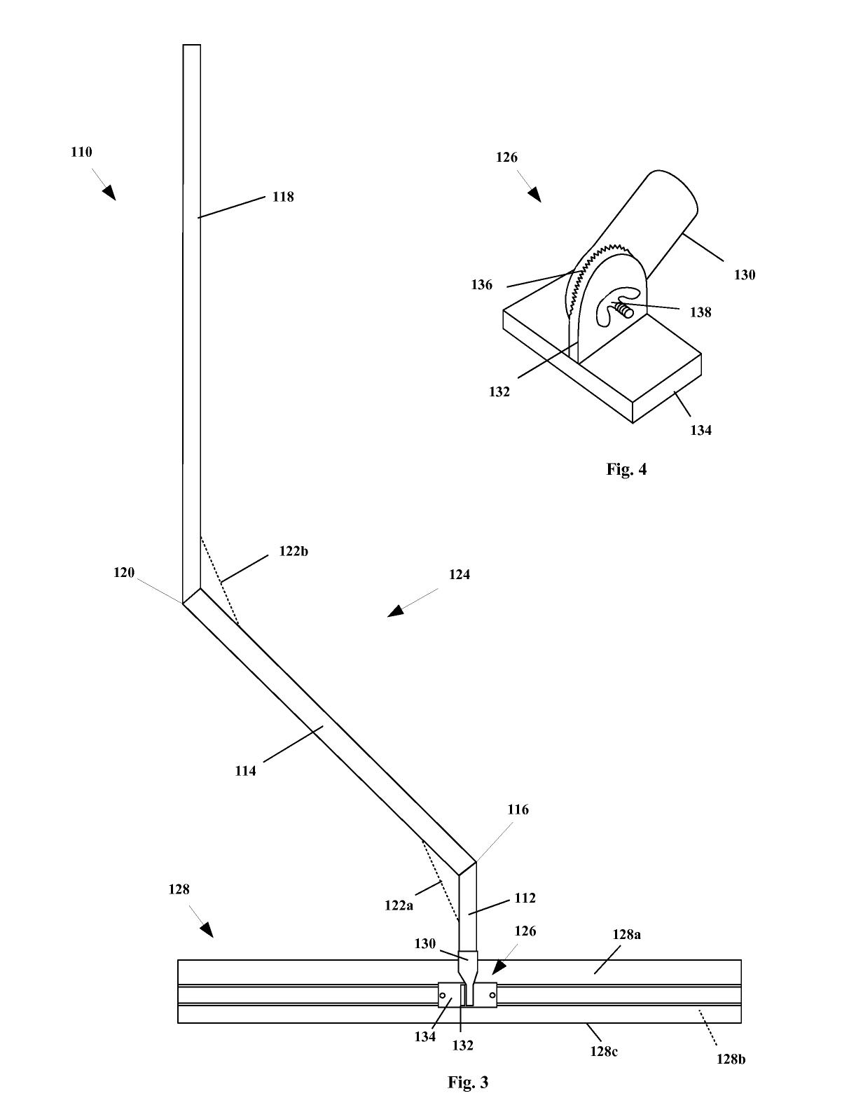

Shown in FIG. 3 is bull float tool 124 of the present invention, which includes a bull float handle assembly 110 attached to a bull float bracket 126, which in turn is attached to a bull float 128. Bull float 128 has a top surface 128a for attachment to bull float bracket 126, a bottom surface 128b that contacts the wet concrete, and a leading edge 128c. In the preferred embodiment shown in FIG. 3, bull float handle assembly 110 bends at respective first and second bends 116 and 120 such that, when bull float handle assembly 110 is at rest, elongated handle member 118, intermediate member 114 and shaft member 112 are all substantially within the same horizontal plane. In alternative embodiments, one or more of such members may, when tool handle assembly 110 is at rest, be in a different horizontal plane than one or more of the other members, as a result of one of respective first and/or second bends 116 and 120 bending vertically in additional to or instead of bending horizontally. The presence of such vertical bends depends on the specific desired functionality of the resulting tool.

Bull float bracket 126 may be any conventional bracket useful for attaching a bull float to a handle, such as the one shown in FIG. 4. As shown in FIG. 4, bull float bracket 126 includes a sleeve 130 to which shaft member 112 is attached in a suitable manner, for example by welding; by tapering shaft member 112 such that it fits tightly and may be secured within sleeve 130; by using male and female threads such that they mate together; or by any other acceptable means.

In the bull float bracket embodiment shown in FIG. 4, sleeve member 130 adjoins a vertical arm 132 of base member 134. Sleeve member 130 and vertical arm 132 have alternately corresponding grooves 136 that mate so as to fix sleeve member 130 in place relative to vertical arm 132. The use of a screw and wingnut assembly 138 permits the quick adjustment of the pitch of sleeve 130 (and resultantly of bull float handle assembly 110) to suit the individual height needs of a given worker.

In another embodiment, bull float bracket 126 may include a conventional worm gear assembly to permit the leading edge 128c of bull float 128 to angle upward in response to axial rotation of elongated bull float handle 118.

As will be readily apparent to one of skill in the art, any conventional bull float bracket may be used in the present invention, the bull float bracket shown in FIG. 4 being only one suitable embodiment. Other suitable brackets include those that permit the sleeve to move freely so as not to fix the pitch of the bull float handle assembly, thus permitting the free movement of the bull float handle assembly during use. This may be desired in certain applications, such as where greater maneuverability of the bull float tool is required.

Alternatively, the sleeve may be generally fixed in place as a result of tension against a base member vertical arm, permitting the pitch of the bull float handle to be adjusted as needed by applying sufficient force greater than such tension, while otherwise remaining fixed in position. In another embodiment, lateral movement of the sleeve may, for certain applications, be permitted in addition to vertical movement.

Likewise, bull float 128 may be any conventional bull float, and may be manufactured of, for example and without limitation, aluminum, magnesium or wood (e.g., laminated poplar). Various types, shapes and sizes of bull floats are well known in the art, for example conventional bull floats are generally between 42 and 48 inches in length and are about 8 inches wide, and have rectangular or circular ends. Generally, the particular bull float chosen for use with the inventive tool handle assemblies and in tools of the present invention will depend on the specific application for which it is to be used.

Examples of bull float brackets and bull floats suitable for use in the present invention include, for example and without limitation, those disclosed in U.S. Pat. Nos. D333,245, D324,980, 988,457, 2,410,343, 2,999,261, 3,162,881, 3,233,948, 3,798,701, 3,936,210, 4,335,485, 4,397,581, 4,520,527, 4,722,637, 4,723,869, 4,856,932, 4,892,437, 5,393,168, 5,467,496, 5,687,448, 6,827,523, and 6,923,595, each of which is hereby incorporated by reference in its entirety.

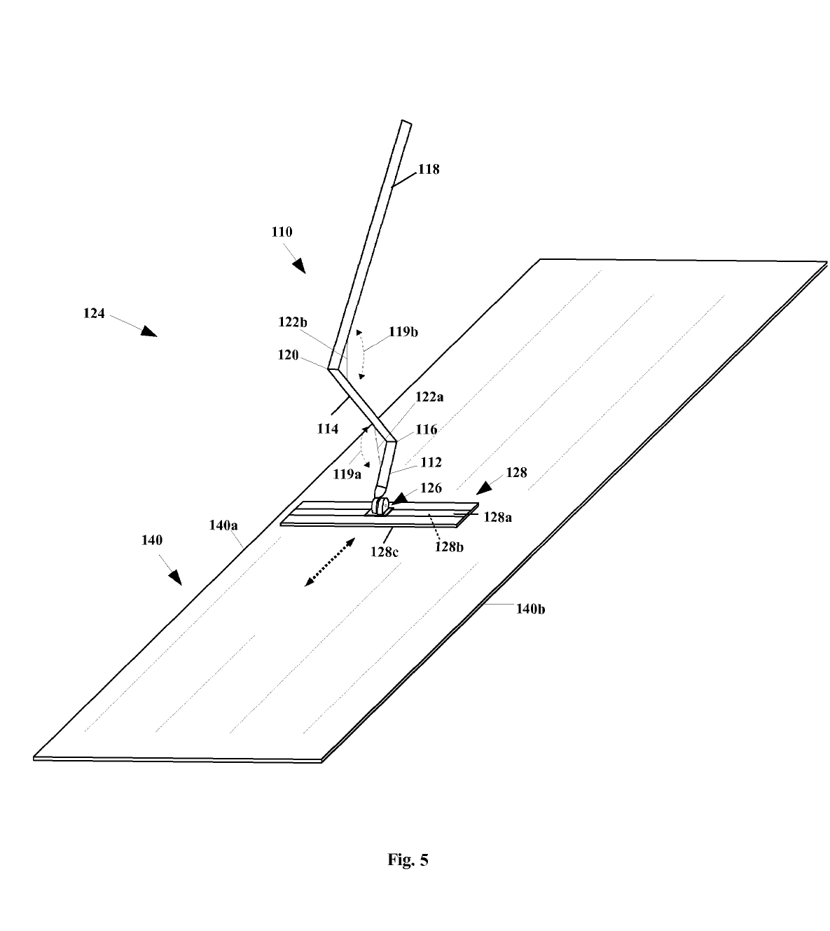

Turning to FIG. 5, a top perspective view of a bull float tool 124 of the present invention is shown in reference to a sidewalk 140 being formed of wet concrete. As discussed above, in a preferred embodiment, bull float handle assembly 110 bends at first bend 116 and second bend 120 such that, when bull float handle assembly 110 is at rest, elongated handle member 118, intermediate member 114 and shaft member 112 all lay substantially within the same horizontal plane.

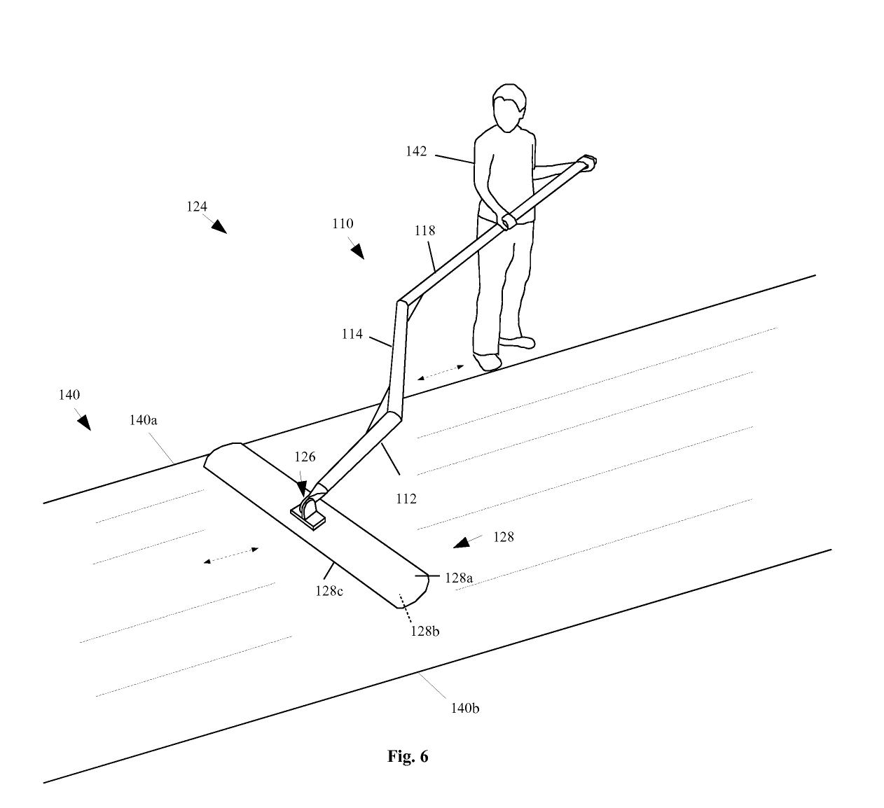

As further shown in FIG. 5, the unique shape of the inventive tool handle assemblies results in at least a portion of elongated handle member 118 being situated outside the perimeter of sidewalk 140 while bull float tool 124 is in use, thus permitting a worker to use bull float tool 124 while walking adjacent and in substantially parallel orientation to the forms of sidewalk 140, as shown in FIG. 6.

In this regard, first bend 116 results from intermediate member 114 being offset from the longitudinal axis of shaft member 112, so as to form a first inner angle 119a of preferably greater than 90 degrees and less than 180 degrees therebetween, as shown by dotted line in FIG. 5. Likewise, second bend 120 results from elongated handle member 118 being offset from the longitudinal axis of intermediate member 114, so as to form a second inner angle 119b of preferably greater than 90 degrees and less than 180 degrees therebetween, as shown by dotted line. In one preferred embodiment, each of angles 119a and 119b are approximately 135 degrees, which has been found to result in a shape that imparts desired functionality to bull float tool 124. To state that a first member is offset from the longitudinal axis of a second member means, for example and without limitation, that the two members, when adjoined, do not form a 180 degree angle.

However, as will be readily apparent to one of skill in the art, such angles are not limited to any particular degree or range of degrees, they may in fact be any degree that permits bull float tool 124 to be used in its intended manner, such as shown in FIG. 6. In the embodiment shown in FIG. 5, optional support members 122a and 122b are respectively present within bends 116 and 120 to add additional strength to bull float handle assembly 110, which has been found beneficial for the use of bull float tool 124 in the manner demonstrated in FIG. 6.

FIG. 6 shows a top perspective view of a bull float tool 124 of the present invention in use by a worker 142. As shown in FIG. 6, worker 142 generally uses the inventive bull float tool 124 to finish sidewalk 140 by walking adjacent and in substantially parallel orientation to the near edge 140a of sidewalk 140 and grasping elongated handle member 118. Worker 142 then pushes bull float tool 124 in a forward direction and then draws it backward, as indicated by dotted line, so that the bottom surface 128c of bull float 128 moves over the surface of the wet concrete, thereby smoothing it. Additionally, worker 142 may cause the leading edge 128c of bull float 142 to angle slightly upward as it is pushed forward, to prevent it from gouging the wet concrete.

As will be appreciated by one of skill in the art, the unique shape of the present invention offers numerous advantages over known bull float handles. For example, when used to finish a sidewalk, conventional bull float tools generally require the worker to be oriented and work substantially perpendicular to the forms supporting the wet concrete, thus permitting the worker to work only on a relatively small cross-sectional area of the sidewalk at any given time. By contrast, a worker may use a bull float tool of the present invention while walking alongside the sidewalk, thus permitting him to work on a relatively larger area with each pass and greatly reducing his need to stretch and extend his reach; bend excessively; work backward; and step in the wet concrete, in order to produce a proper finish on the sidewalk. As the leading edge of the bull float is generally made to angle upward when the bull float tools is pushed forward, and as several passes over the wet concrete are typically required to achieve a desirable finish, the reduced labor needed to use bull float tools of the present invention are yet further enhanced.

Moreover, as time is generally of the essence during the finishing process, due to the gradual change in the workability of the concrete once poured, the time savings afforded by the present invention may further allow a greater amount of concrete to be mixed and poured at one time, and/or reduce the level of skill required by the worker to ensure a proper finish. As a result of these and other benefits, significant labor, time and cost savings may be realized.

Further, tool handle assemblies and tools of the present invention may be used in other applications, including any application where conventional bull float tools are used. For example, there may be circumstances where the inventive bull float tools are used with the worker oriented substantially perpendicular to the material being finished with respect to its length. In such cases, the inventive bull float tools may be used to finish material located off to one side of the worker (with respect to known bull float tools), and then likewise used to finish material located off to the other side of the worker simply by changing the position of the tool. As such, a relatively large area may be finished without the worker substantially changing his position. Moreover, the inventive tools, by nature of their unique design, may be able to reach areas that cannot be reached by conventional bull float tools.

Despite the numerous aforementioned and other benefits provided by the inventive tool handle assemblies and tools, which will be readily recognized by those of skill in the art, tools of the present invention may nonetheless be manufactured/machined out of conventional materials and produced at similar cost to conventional bull float tools. They may further exist in any number of embodiments, for example permanent, such as where all members are welded together, or portable, such as where the tool handle assembly may be broken down for ready transport, and the individual members may further be broken down if desired (for example, the elongated handle member may be collapsible). Such portable embodiments may be provided as kits alone or in combination with other components of the tool.

The inventive tool handle assemblies and tools of the present invention may be manufactured of a variety of materials suitable for various purposes, and generally provide the same ease of use as conventional bull float tools. Moreover, as they are adaptable to existing and future bull float brackets and bull floats, workers already having such equipment may enjoy the numerous benefits afforded by the inventive tool handle assemblies and tools without needing to unnecessarily purchasing additional equipment.

Once given the above disclosure, many other features, modifications, and improvements will become apparent to the skilled artisan. Such other features, modifications, and improvements are therefore considered to be part of this invention, the scope of which is to be determined by the following claims:

What is claimed is:

1. A tool handle assembly, comprising:
a shaft member which is capable of direct or indirect attachment to a finishing member;
an intermediate member cooperative with said shaft member, wherein said intermediate member is offset from the longitudinal axis of said shaft member; and
an elongated handle member cooperative with said intermediate member, wherein said elongated handle member is offset from the longitudinal axis of said intermediate member;
wherein said shaft member, said intermediate member and said handle member together define a tool handle assembly that is capable of direct or indirect attachment to a finishing member to form a finishing tool, and
wherein said handle member is so elongated as to permit a worker using a finishing tool employing said tool handle assembly to cause said finishing member to contact and move substantially horizontally across the surface of a material.

2. A tool handle assembly of claim 1, wherein said finishing member is a bull float.

3. A tool handle assembly of claim 1, wherein said material is concrete.

4. A tool handle assembly of claim 1, further comprising one or more support members, each adjoining at least two members selected from the group consisting of said shaft member, said intermediate member, and said elongated handle member.

5. A tool handle assembly of claim 1, wherein said intermediate member is offset from the longitudinal axis of said shaft member, so as to form an inner angle of more than 90 degrees and less than 180 degrees therebetween.

6. A tool handle assembly of claim 5, wherein said inner angle is about 135 degrees.

7. A tool handle assembly of claim 1, wherein said elongated handle member is offset from the longitudinal axis of said intermediate member, so as to form an inner angle of more than 90 degrees and less than 180 degrees therebetween.

8. A tool handle assembly of claim 7, wherein said inner angle is about 135 degrees.

9. A bull float tool, comprising:
a tool handle assembly of claim 1;
a bull float bracket, and
a finishing member.

10. A bull float tool of claim 9, wherein said finishing member is a bull float.

11. A bull float tool, comprising:
a shaft member;
a bull float, wherein said shaft member is directly or indirectly attached to said bull float;
an intermediate member cooperative with said shaft member, wherein said intermediate member is offset from the longitudinal axis of said shaft member;
an elongated handle member cooperative with said intermediate member, wherein said elongated handle member is offset from the longitudinal axis of said intermediate member;
wherein said handle member is so elongated as to permit a worker using said bull float tool to cause said bull float to contact and move substantially horizontally across the surface of a material.

12. A bull float tool of claim 11, further comprising a bull float bracket.

13. A bull float tool of claim 11, wherein said material is concrete.

14. A bull float tool of claim 11, further comprising one or more support members, each adjoining at least two members selected from the group consisting of said shaft member, said intermediate member, and said elongated handle member.

15. A tool handle assembly of claim 11, wherein said intermediate member is offset from the longitudinal axis of said shaft member, so as to form an inner angle of more than 90 degrees and less than 180 degrees therebetween.

16. A tool handle assembly of claim 15, wherein said inner angle is about 135 degrees.

17. A tool handle assembly of claim 11, wherein said elongated handle member is offset from the longitudinal axis of said intermediate member so as to form an inner angle of more than 90 degrees and less than 180 degrees therebetween.

18. A tool handle assembly of claim 17, wherein said inner angle is about 135 degrees.

19. A kit, comprising:
a tool handle assembly shaft member which is capable of direct or indirect attachment to a finishing member;
a tool handle assembly intermediate member which may be joined with said shaft member, such that said intermediate member is offset from the longitudinal axis of said shaft member; and
a tool handle assembly elongated handle member which may be joined with said intermediate member, such that said elongated handle member is offset from the longitudinal axis of said intermediate member;
wherein said tool handle assembly shaft member, said intermediate member and said handle member may be joined to form a tool handle assembly that is capable of direct or indirect attachment to a finishing member to form a finishing tool, and
wherein said handle member is so elongated as to permit a worker using a finishing tool employing said tool handle assembly to cause said finishing member to contact and move substantially horizontally across the surface of a material.

20. A bull float tool, comprising:
a shaft member;
a bull float bracket attached to said shaft member;
a bull float attached to said bull float bracket;
an intermediate member cooperative with said shaft member, wherein said intermediate member is offset from the longitudinal axis of said shaft member;
an elongated handle member cooperative with said intermediate member, wherein said elongated handle member is offset from the longitudinal axis of said intermediate member;
wherein said handle member is so elongated as to permit a worker using said bull float tool to cause said bull float to contact and move substantially horizontally across the surface of a material.

21. A method of finishing concrete, said method comprising the steps of:
(a) providing a bull float tool, wherein said bull float tool comprises:
a shaft member;
a bull float, wherein said shaft member is directly or indirectly attached to said bull float;
an intermediate member cooperative with said shaft member, wherein said intermediate member is offset from the longitudinal axis of said shaft member;
an elongated handle member cooperative with said intermediate member, wherein said elongated handle member is offset from the longitudinal axis of said intermediate member;
wherein said handle member is so elongated as to permit a worker using said bull float tool to cause said bull float to contact and move substantially horizontally across the surface of a material being finished; and
(b) contacting said bull float tool with a wet concrete surface.
